(19) United States
(12) Patent Application Publication
(10) Pub. No.: US 2005/0015476 A1
(43) Pub. Date: Jan. 20, 2005

(54) Network element system for providing independent multi-protocol service

(76) Inventors: Jee-Won Jeong, Anyang-shi (KR); Young-Seok Kim, Songnam-shi (KR)

Correspondence Address: CHA & REITER, LLC, 210 ROUTE 4 EAST STE 103, PARAMUS, NJ, 07652, US

(21) Appl. No.: 10/705,355

(22) Filed: Nov. 10, 2003

(30) Foreign Application Priority Data
Jun. 18, 2003 (KR) 2003-39423

(51) Int. Cl. G06F 15/173; G06F 15/16

(52) U.S. Cl. 709/223; 709/230

(57) ABSTRACT

An agent device based on an independent architecture for supporting multiple protocols used to control network elements (NEs) in an NE (Network Element) system. Management systems supervise operations of the NEs and provide services for the NEs. The NEs configure a network, and are managed by the management systems. A domain service bridge is arranged between the NEs and the management systems. The domain service bridge is coupled to the NEs through a protocol for use in the NEs, and the domain service bridge is coupled to the management systems through protocols corresponding to the management systems.

### CLAIM OF PRIORITY

This application claims priority to an application entitled “NETWORK ELEMENT SYSTEM FOR PROVIDING INDEPENDENT MULTI-PROTOCOL SERVICE,” filed in the Korean Intellectual Property Office on Jun. 18, 2003 and assigned Serial No. 2003-39423, the contents of which are hereby incorporated by reference.

### BACKGROUND OF THE INVENTION

1. Field of the Invention

The present invention relates to an agent device based on an independent architecture for supporting multiple protocols used to control network elements (NEs) in an NE system.

2. Description of the Related Art

Protocols such as TL1 (Transaction Language 1) and SNMP (Simple Network Management protocol) are utilized a basic network management protocol that supervises operations of Network Elements (NEs) in a conventional NE system made up of NEs and a network management device.

These protocols cannot, however, effectively perform the myriad of management functions, e.g., a network management function, equipment management function, with the onset of large-capacity Internet services that make networks more complex. As a further consequence, and concomitant with the prevalence of the TMN (Telecommunication Management Network) concept, CMIP (Common Management Information Protocol) is now globally used for large-scaled network management is globally used. A CORBA (Common Object Request Broker Architecture) protocol, a high-level protocol compatible with a Windows system, Unix system, Linux system, etc., is used to maximize operability of each system, since various OS (Operating System) platforms are required.

FIG. 1 shows the configuration of a conventional NE system which includes an NMS (Network Management System 10-1 and EMSs (Element Management Systems) 10-2, 10-3 and 10-4, external conversion servers 11-1, 11-2 and 11-3 for coupling corresponding management systems to protocols for the management systems, and NEs 12 being managed in the network. Each NE 12 internally includes an MO (Managed Object) 122 to be managed and an agent 121 embedded in the NE 12 for coupling the MO 122 to an external protocol.

Here, the EMSs 10-2, 10-3 and 10-4 are systems which manage the NEs (containing optical terminal equipment, optical relay equipment, etc.), and manage the functions and performances associated with the NEs. The EMSs 10-2, 10-3 and 10-4 are integrated and operated with a high-level network management system to carry out an integrated management operation for elements of another communication network. Further, the EMSs are provided to support operation of a telecommunication management network layer, such that QoS (Quality of Service) requirements can be appropriately satisfied and a new service can be appropriately provided.

The NMS 10-1 is a computer system which supports a network management task, collects and accumulates state information, alarm information, traffic data, etc. associated with the network from a switch, computes network management parameters or statistical data, and controls traffic incoming into the switch. The NMS 10-1 controls a network supervisor of a network management center and a network control terminal. The NMS 10-1 is referred to as a network management operations system in ITU-T (International Telecommunications Union-Telecommunication) Recommendations t.411.

The external conversion servers 11-1, 11-2 and 11-3 convert a protocol used in the NE 12 into a protocol used in the NMSs 10-1, 10-2, 10-3 and 10-4.

FIG. 2A further illustrates the external conversion server 11-2 for supporting the CMIP in the conventional NE system. As can be seen from FIG. 2A, the external conversion server 11-2 needs a vendor-defined protocol communicator 204 to implement the vendor-defined protocol used for the NE 12, and further requires a converter 203 for carrying out a message conversion operation. Related data items are stored in the form of GDMO (Guidelines for Definition of Managed Objects) 202. Illustratively, the external conversion server 11-2 includes a CMIP agent 201 for supporting the CMIP used in the EMS 10-2. Data flows between the GDMO 202 and the CMIP agent 201 by means of IPC (Inter Processor Communication), is collected by the agent, and is then transferred to the EMS 10-2.

FIG. 2B likewise further illustrates the external conversion server 11-3 for supporting the SNMP in the conventional NE system. Similarly to the previously-described server 11-2, the external conversion server 11-3 needs a vendor-defined protocol communicator 208 to implement the vendor-defined protocol used for the NE 12, a nd a converter 207 for carrying out a message conversion operation. Related data items are stored in a format of an MIB (Management Information Base) 206. The external conversion server 11-3 includes an SNMP agent 205 for supporting SNMP used in the EMS 10-3. The data transmitted between the MIB 206 and the SNMP agent 205 is collected through IPC (Inter Processor Communication), and the collected data is transferred to the EMS 10-3.

Problematically, the element provider for NEs cannot appropriately support the various protocols associated with the management systems where each NE is coupled to various network management systems. Integrated management for the various NEs is made particularly difficult by the fact that a network management system provider uses not only various standard protocols, but also protocols defined by the provider. A trend has therefore development in which respective service providers install NEs and make an effort to integrate different operation protocols for the network management systems. In particular, because control protocols associated with pieces of network equipment serving as NEs are different from each other, a separate management system is needed to convert operation protocols for the pieces of network equipment into a compatible protocol or, alternatively, NMSs must be developed to support all operation protocols so that various types of network equipment supplied to communication service providers can be entirely managed. Consequently, significant time and manpower are needed. Furthermore, databases must be separately provided for the multiple external conversion servers 11-1, 11-2 and 11-3 according to various protocols.

### SUMMARY OF THE INVENTION

The present invention has been made in view of the above problems, and, in one aspect, provides an NE (Network Element) system including an agent device based on an independent architecture for supporting multiple protocols used to control respective NEs, affording an independent multi-protocol service.

In another aspect, the present invention provides an NE (Network Element) system affording to an NE protocols irrespective of types of protocols by externally installing a service bridge (e.g., an external agent) separated from the NE and used to support only protocols. Consequently, different operation protocols according to different developers can be entirely managed and service based on the different operation protocols can be efficiently provided.

In accordance with an aspect of the present invention, an NE (Network Element) system provides an independent multi-protocol service, comprising: NEs for configuring a network; management systems for supervising operations of the NEs and providing services for the NEs; and a domain service bridge arranged between the NEs and the management systems, wherein the domain service bridge is coupled to the NEs through a protocol for use in the NEs, and the domain service bridge is coupled to the management systems through protocols corresponding to the management systems.

### BRIEF DESCRIPTION OF THE DRAWINGS

The above and other objects, features and other advantages of the present invention will be more clearly understood from the following detailed description taken in conjunction with the accompanying drawings, in which same or similar elements are annotated identically throughout the several views:

FIG. 1 is a block diagram illustrating the configuration of a conventional NE (Network Element) system;

FIGS. 2A and 2B are block diagrams illustrating external conversion servers provided in the conventional NE system;

FIG. 3 is an exemplary block diagram illustrating the configuration of an NE (Network Element) system in accordance with a preferred embodiment of the present invention; and

FIG. 4 is a block diagram illustrating, as an example, the configuration of a domain service bridge in accordance with a preferred embodiment of the present invention.

### DETAILED DESCRIPTION OF THE PREFERRED EMBODIMENTS

Preferred embodiments of the present invention will be described in detail with reference to the annexed drawings. In the following description, detailed description of known functions and configurations incorporated herein will be omitted for clarity of presentation.

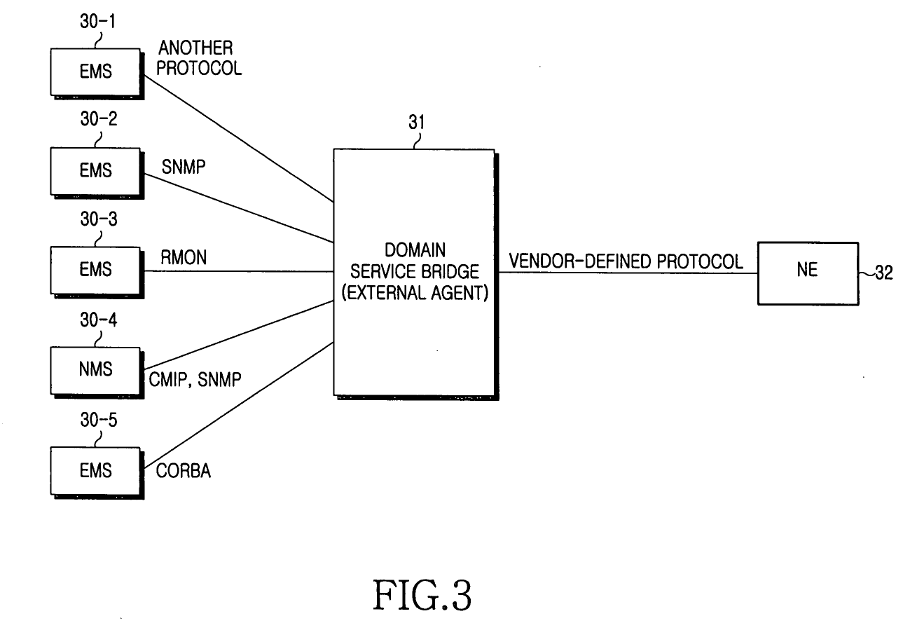

FIG. 3 is a block diagram illustrating, by way of non-limitative example, the configuration of an NE (Network Element) system in accordance with a preferred embodiment of the present invention. The NE system includes management systems containing an NMS (Network Management System) 30-4 and EMSs (Element Management Systems) 30-1, 30-2, 30-3, 30-5, a domain service bridge 31 for coupling a corresponding management system to an appropriate protocol, and NEs 32 being managed in the network.

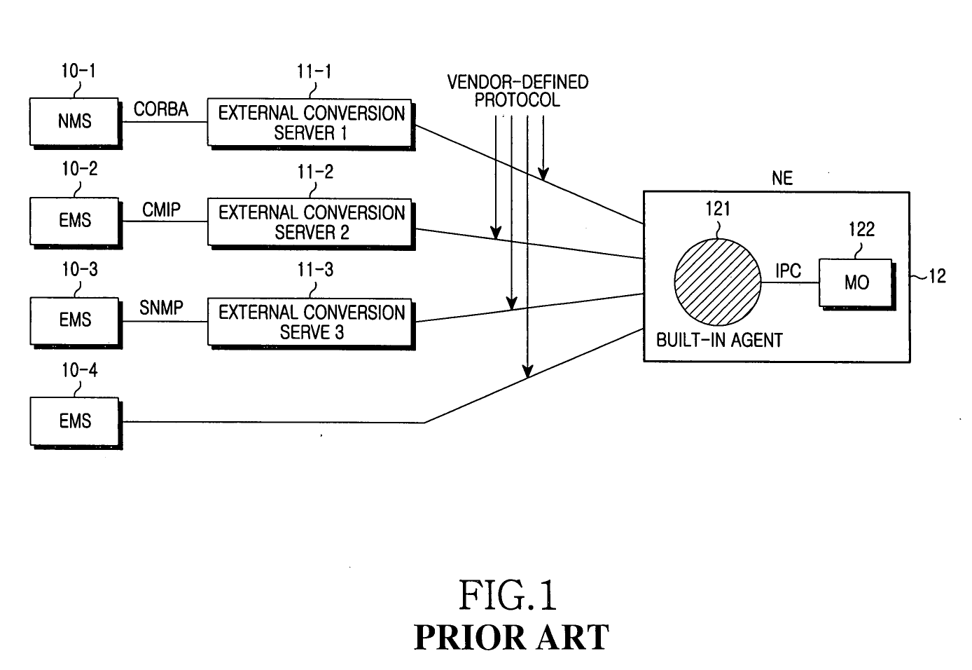

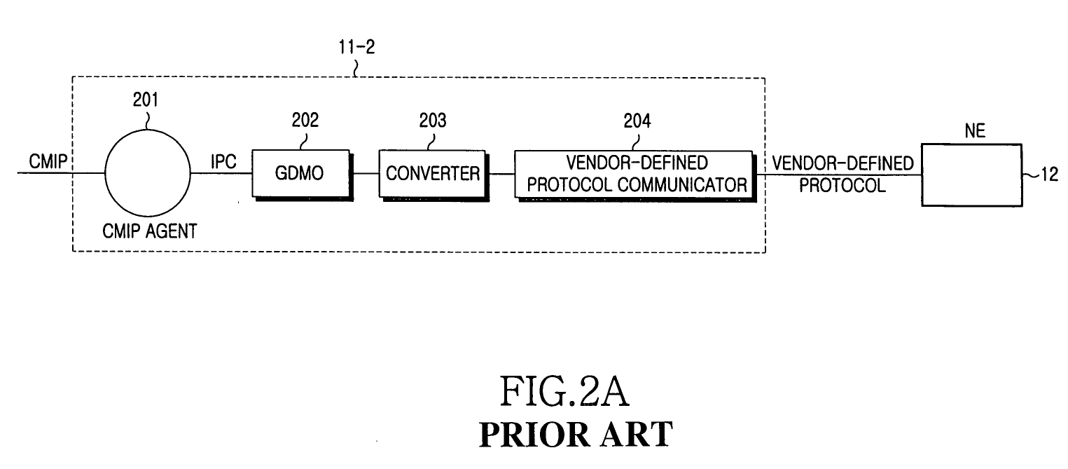

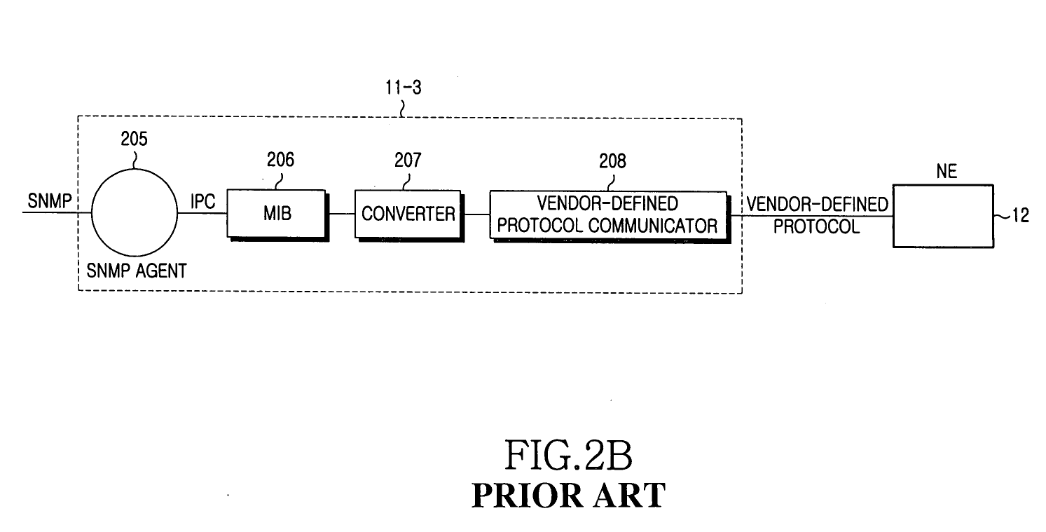

Here, the EMSs 30-1, 30-2, 30-3 and 30-5 are systems that correspond functionally with the EMSs 10-2, 10-3, 1-4 shown in FIG. 1. Likewise, the NMS 30-4 is a computer system that functionally corresponds with the NMS 10-1 shown in FIG. 1.

As shown in FIG. 3, the EMSs and NMS support different types of protocols. Starting from the top of FIG. 3, the EMS 30-1 supports “another protocol.” The EMS 30-2 supports SNMP (Simple Network Management protocol), and the EMS 30-3 supports an RMON (Remote Network Monitoring) protocol. The NMS 30-4 supports CMIP (Common Management Information Protocol) and SNMP (Simple Network Management protocol). The EMS 30-5 supports a CORBA (Common Object Request Broker Architecture) protocol. As described above, the NE system supports various protocols.

As the NE 32 is based on only one specific protocol in accordance with the present invention, it is coupled to the domain service bridge 31 through the specific protocol.

By contrast, the domain service bridge 31 arranged between the NE 32 and the management systems supports different protocols. In other words, although the NE 32 is coupled to a vendor-defined protocol, the EMSs 30-1, 30-2, 30-3, 30-5 and the NMS 30-4 are coupled to the SNMP, RMON protocol, CMIP, CORBA protocol, etc. Accordingly, management information for the NE 32 can be transferred from the domain service bridge 31 through a specific vendor-defined protocol. All information items associated with the NE 32 are transferred to the domain service bridge 31 through the specific vendor-defined protocol, and the transferred information items are stored as objects to be internally managed by the domain service bridge 31.

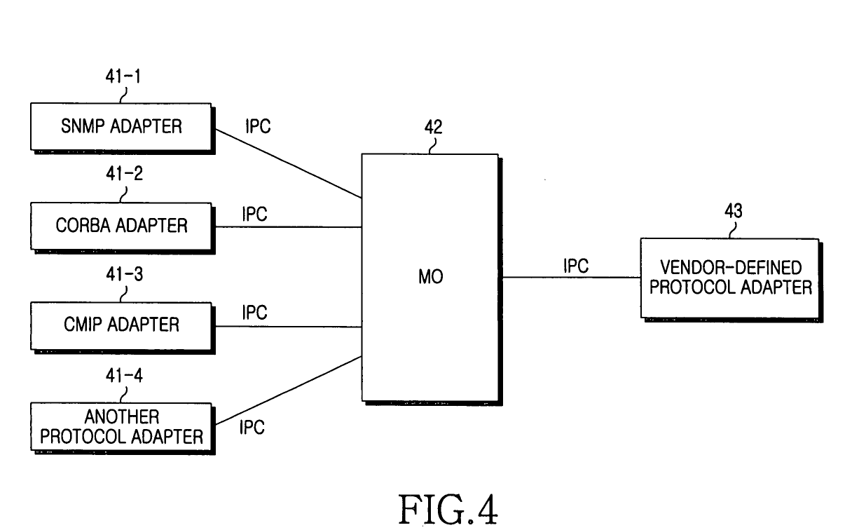

FIG. 4 is a block diagram illustrating an exemplary configuration of the domain service bridge 31 in accordance with a preferred embodiment of the present invention. Included within the domain service bridge 31 is an MO (Managed Object) 42, a vendor-defined protocol adapter 43 for coupling the domain service bridge to the NE 32, and an SNMP adapter 41-1, a CORBA adapter 41-2, a CMIP adapter 41-3 and another protocol adapter 41-4 which couple the domain service bridge 31 to external management systems.

Here, the MO 42 is used for managing the external management systems associated with a corresponding NE 32 which provides information. Connections for respective components within the domain service bridge 31 are performed through IPC (Inter Processor Communication).

The EMSs 30-1, 30-2, 30-3, 30-5 and the NMS 30-4 being the external management systems are not directly coupled to the NE 32, but they are coupled to the NE through the domain service bridge 31. The EMSs, NMS, etc. receive information associated with the NE from the domain service bridge 31 and control the NE through the domain service bridge 31.

Notably, because the domain service bridge 31 includes various adaptors for corresponding protocols, management system servers can transmit data based on various types of protocols.

As apparent from the above description, each of various protocol adapters is associated with an MO for the NE and handles the same format MO information. In other words, the SNMP and CMIP are conventionally based on the MIB and the GDMO as independent information items, respectively. However, the SNMP and CMIP are based on the same format MO information in accordance with the present invention so that integrated management can be appropriately performed.

Further, since the present invention uses an external agent mounted in an external server rather than an agent embedded in the NE, an additional protocol extension can easily be easily added, the external agent is not limited in size by the NE's memory capacity, and a protocol independent of management systems can be supported and developed using the external server.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments and drawings, but is rather defined by the below-provided claims.

1. An NE (Network Element) system for providing an independent multi-protocol service, comprising:
a plurality of NEs for configuring a network;
management systems for supervising operations of the plural NEs and providing services for the NEs; and
a domain service bridge arranged between the Nts and the management systems,
wherein the domain service bridge is coupled to the NEs through a protocol for use in the NEs, and the domain service bridge is coupled to the management systems through protocols corresponding to the management systems.

2. The system of claim 1, wherein the corresponding protocols differ from said protocol for use in the NEs.

3. The system of claim 2, wherein the corresponding protocols respectively correspond to the management systems.

4. The system of claim 1, wherein the corresponding protocols respectively correspond to the management systems.

5. The system of claim 1, wherein the domain service bridge comprises:
managed objects being managed by the management systems on the basis of received NE information;
a protocol adapter for coupling the domain service bridge to the NEs; and
a plurality of protocol adapters for coupling the domain service bridge to the management systems.

6. The system of claim 5, wherein the plural protocol adapters differ from said protocol adapter.

7. The system of claim 5, wherein the plural protocol adapters respectively correspond to the management systems.

8. The system of claim 5, wherein the protocols corresponding to the management systems comprise SNMP (Simple Network Management protocol), CMIP (Common Management Information Protocol), CORBA (Common Object Request Broker Architecture) protocol and RMON (Remote Network Monitoring) protocol.

9. The system of claim 1, wherein the protocols corresponding to the management systems comprise SNMP (Simple Network Management protocol), CMIP (Common Management Information Protocol), CORBA (Common Object Request Broker Architecture) protocol and RMON (Remote Network Monitoring) protocol.

10. The system of claim 9, wherein the corresponding protocols differ from said protocol for use in the NEs.

11. An NE (Network Element) method for providing an independent multi-protocol service, comprising:
providing a plurality of NEs for configuring a network;
providing management systems for supervising operations of the plural NEs and providing services for the NEs; and
arranging a domain service bridge between the NEs and the management systems,
wherein the domain service bridge is coupled to the NEs through a protocol for use in the NEs, and the domain service bridge is coupled to the management systems through protocols corresponding to the management systems.

12. The method of claim 11, wherein the corresponding protocols differ from said protocol for use in the NEs.

13. The method of claim 12, wherein the corresponding protocols respectively correspond to the management systems.

14. The method of claim 11, wherein the corresponding protocols respectively correspond to the management systems.

15. The method of claim 11, wherein the domain service bridge comprises:
managed objects being managed by the management systems on the basis of received NE information;
a protocol adapter for coupling the domain service bridge to the Nts; and
a plurality of protocol adapters for coupling the domain service bridge to the management systems.

16. The method of claim 15, wherein the plural protocol adapters differ from said protocol adapter.

17. The method of claim 15, wherein the plural protocol adapters respectively correspond to the management systems.

18. The method of claim 15, wherein the protocols corresponding to the management systems comprise SNMP (Simple Network Management protocol), CMIP (Common Management Information Protocol), CORBA (Common Object Request Broker Architecture) protocol and RMON (Remote Network Monitoring) protocol.

19. The method of claim 11, wherein the protocols corresponding to the management systems comprise SNMP (Simple Network Management protocol), CMIP (Common Management Information Protocol), CORBA (Common Object Request Broker Architecture) protocol and RMON (Remote Network Monitoring) protocol.

20. The method of claim 19, wherein the corresponding protocols differ from said protocol for use in the NEs.
